(19) United States
(12) Patent Application Publication
(10) Pub. No.: US 2022/0205172 A1
(43) Pub. Date: Jun. 30, 2022

(54) ARTIFICIAL LEATHER AND MANUFACTURING METHOD THEREOF

(71) Applicant: SAN FANG CHEMICAL INDUSTRY CO., LTD., KAOHSIUNG CITY (TW)

(72) Inventors: CHIH-YI LIN, KAOHSIUNG CITY (TW); KUO-KUANG CHENG, KAOHSIUNG CITY (TW); KUN LIN CHIANG, KAOHSIUNG CITY (TW); SHIH MING TAI, KAOHSIUNG CITY (TW); DE-YU LI, KAOHSIUNG CITY (TW)

(21) Appl. No.: 17/561,982

(22) Filed: Dec. 26, 2021

(30) Foreign Application Priority Data
Dec. 31, 2020 (TW) 109147183

(51) Int. Cl. D06N 3/14; D06N 3/00

(52) U.S. Cl. CPC D06N 3/145; D06N 3/0006; D06N 2211/28; D06N 3/0036; D06N 3/0011

(57) ABSTRACT

The present disclosure is relates to an artificial leather and a manufacturing method thereof. The artificial leather includes a substrate, an adhering glue layer, a moldable surface layer, a TPU adhering layer, a TPU layer and a bottom layer. The substrate includes a first surface and a second surface. The adhering glue layer is disposed on the first surface of the substrate. The moldable surface layer is disposed on the adhering glue layer. The TPU adhering layer is disposed on the second surface of the substrate. The TPU is disposed on a surface of the TPU adhering layer. The bottom layer is disposed on a surface of the TPU layer. The moldable surface layer of the artificial leather has a texture of leather and color effect. The bottom layer has a villus effect and high wear resistance.

### FIELD

The disclosure relates to an artificial leather and a manufacturing method thereof.

### BACKGROUND

Conventional methods for manufacturing an artificial leather generally use various complicated processes, and some of the processes require solvents, such as liquid caustic soda (NaOH), which is harmful to the environment and does not meet requirements for environmental friendliness. In addition, the conventional artificial leather has only one side treated, and the wear resistance is not good, which makes it unsuitable for application in leather products.

### SUMMARY OF THE INVENTION

In accordance with one aspect of the present disclosure, an artificial leather includes a substrate, an adhering glue layer, a moldable surface layer, a TPU adhering layer, a TPU layer and a bottom layer. The substrate includes a first surface and a second surface. The second surface is opposite to the first surface. The adhering glue layer is disposed on the first surface of the substrate. The moldable surface layer is disposed on the adhering glue layer. The TPU adhering layer is disposed on the second surface of the substrate. The TPU is disposed on a surface of the TPU adhering layer. The bottom layer is disposed on a surface of the TPU layer.

In accordance with another aspect of the present disclosure, a manufacturing method of an artificial leather includes: preparing a substrate, the substrate having a first surface and a second surface, the second surface being opposite to the first surface; melt-blowing a TPU adhering layer onto the second surface of the substrate; melt-blowing a TPU layer onto a surface of the TPU adhering layer; thermally bonding the substrate, the TPU adhering layer and the TPU layer; bonding a bottom layer onto a surface of the TPU layer; preparing a moldable surface layer; applying an adhering glue layer onto a surface of the moldable surface layer; and bonding the moldable surface layer and the adhering glue layer onto the first surface of the substrate.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic structural diagram showing an artificial leather according to an embodiment of the present disclosure.

FIG. 2 shows a flowchart of a manufacturing method of an artificial leather according to an embodiment of the present disclosure.

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that when an element is referred to as being “on” another element, it can be directly on the other element or intervening elements may be present. In contrast, when an element is referred to as being “directly on” another element, there are no intervening elements present.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

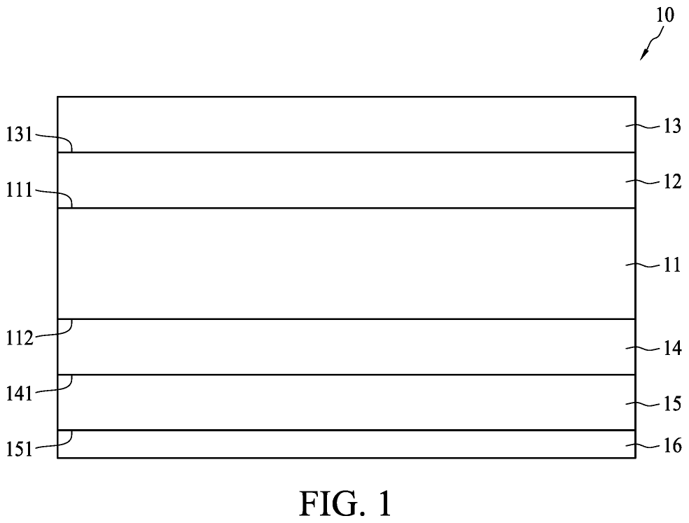

FIG. 1 is a schematic structural diagram showing an artificial leather according to an embodiment of the present disclosure. In an embodiment, the artificial leather 10 of the present disclosure includes a substrate 11, an adhering glue layer 12, a moldable surface layer 13, a TPU adhering layer 14, a TPU layer 15 and a bottom layer 16.

In an embodiment, the substrate 11 has a first surface 111 and a second surface 112. The second surface 112 is opposite to the first surface 111. The substrate 11 may be a woven fabric, a non-woven fabric or a mesh fabric, or a different material may be used according to actual needs to satisfy actual applications. In an embodiment, at least part of the substrate is an environmentally friendly material, that is, part or all of the substrate is an environmentally friendly material. For example, 100% recycled PET cotton or a mixture of 60% recycled PET and 40% common PET is entangled into a non-woven fabric by needle punching. Alternatively, 100% recycled PET fibers or common PET fibers are woven into a woven fabric. In an embodiment, a fiber fineness of the substrate 11 may be 0.05-6 μm.

In an embodiment, the adhering glue layer 12 is disposed on the first surface 111 of the substrate 11. In an embodiment, the adhering glue layer has a solid content of 20%-99% and a viscosity of 5,000-50,000 cps. In an embodiment, the adhering glue layer is a resin.

In an embodiment, the moldable surface layer 13 is disposed on the adhering glue layer 12. In an embodiment, the moldable surface layer 13 has a solid content of 10%-99% and a viscosity of 500-15,000 cps. In an embodiment, the moldable surface layer 13 is a moldable resin. In an embodiment, the moldable surface layer 13 may be mixed with a pearlescent or color paste to provide surface color changes and texture.

In an embodiment, the TPU adhering layer 14 is disposed on the second surface 112 of the substrate 11. In an embodiment, a thickness of the TPU adhering layer 14 is 0.05-0.15 mm. In an embodiment, the thickness of the TPU adhering layer 14 may be 0.15 mm.

In an embodiment, the TPU layer 15 is disposed on a surface 141 of the TPU adhering layer 14. A thickness of the TPU layer 15 is 0.15-0.35 mm. In an embodiment, the thickness of the TPU layer 15 may be 0.3 mm.

In an embodiment, the bottom layer 16 is disposed on a surface 151 of the TPU layer 15. In an embodiment, the bottom layer 16 has a solid content of 5%-50% and a viscosity of 20-2,000 cps. The bottom layer 16 may be a resin.

In an embodiment, in a wear test using a wear test machine (STOLL tester), first, an air table on a turntable was confirmed. After the air table was pressurized, the height of the leather diaphragm was 15 mm, and the pressure value was 6±0.5 PSI. A test piece with a diameter of 112 mm was placed on the turntable and fixed. Using sand paper (Model K225-320J), a special weight of 0.5 pound for inside was added as an adhesion weight, and an abrasion test was carried out. For the first 25 cycles in each test, whether the material was fixed was confirmed. Every 300 cycles, it was necessary to evaluate whether the sand paper and the test piece were in good condition. The test results showed that a wear strength of the artificial leather 10 of the present disclosure was greater than 3,000 cycles, as shown in Table 1 below.

TABLE 1
Test results

| Test Item | | Unit | Result |
|---|---|---|---|
| Wear resistance | ASTM D3884 | Cycles | 200+ |
| (Taber Abrasion) | (H22*500 g) | | |
| Wear resistance | GE-63 | Cycles | 25,000+ |
| (Abrasion) | (12 Kpa) | | |
| Ambient-temperature | SATRA PM55 | Cycles | 100,000+ |
| flex resistance | | | |
| (Bally Flex (RT)) | | | |
| Light fastness (QUV) | NIKE G37 | 40° C. | 4.0↑ |
| | | *40 W*24 hrs | |
| Hydrolysis resistance | NIKE G57 | 24 hrs | PASS |
| (Hydrolysis) | | | |
| Peeling (Ply Adhesion) | EN ISO 2411 | kg/3 cm | 4.5↑ |

Therefore, the moldable surface layer 13 of the artificial leather 10 of the present disclosure has a texture of leather or color effect. The bottom layer 16 has a villus effect and high wear resistance.

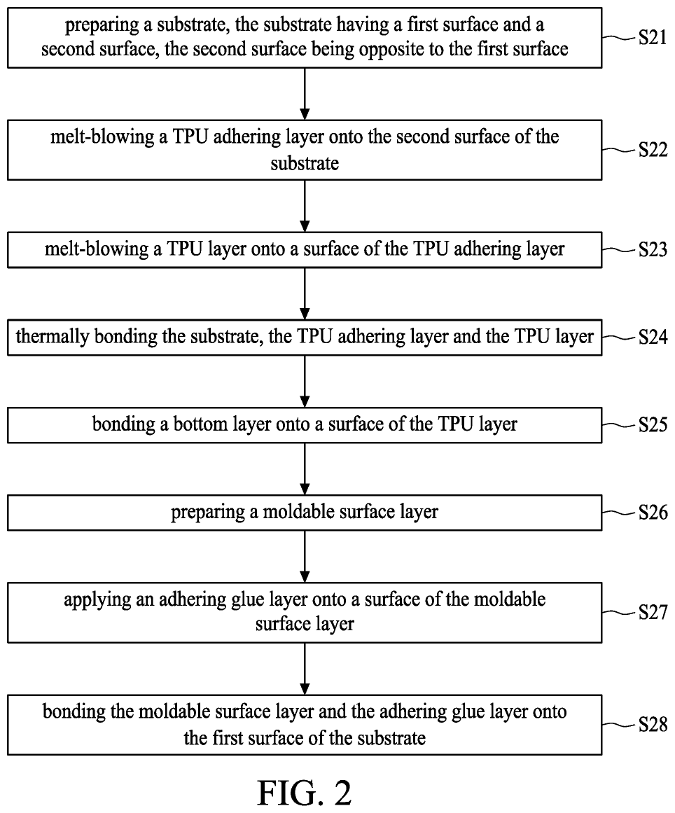

FIG. 2 shows a flowchart of a manufacturing method of an artificial leather according to an embodiment of the present disclosure. With reference to FIG. 1 and FIG. 2, referring to step S21 first, a substrate 11 is provided. The substrate 11 has a first surface 111 and a second surface 112. The second surface 112 is opposite to the first surface 111. The substrate 11 may be a woven fabric, a non-woven fabric or a mesh fabric, or a different material may be used according to actual needs to satisfy actual applications. In an embodiment, at least part of the substrate is an environmentally friendly material, that is, part or all of the substrate is an environmentally friendly material. For example, 100% recycled PET cotton or a mixture of 60% recycled PET and 40% common PET is entangled into a non-woven fabric by needle punching. Alternatively, 100% recycled PET fibers or common PET fibers are woven into a woven fabric.

Referring to step S22, a TPU adhering layer 14 is melt-blown onto the second surface 112 of the substrate 11. In an embodiment, the step of melt-blowing the TPU adhering layer 14 further includes the following operations. Low-melting TPU particles, having a melting point of 100-150° C. and a Shore hardness of 70-90 A, are dried at a predetermined drying temperature for 4 hours until the water content is 100 ppm or below. The predetermined drying temperature is 60-80° C.

In an embodiment, in the step of melt-blowing the TPU adhering layer 14, the TPU particles are molten by a first extruder (not shown). The first extruder has a melting temperature of 80° C.-250° C., a die-head temperature of 210° C.-250° C., a DIE temperature of 210° C.-250° C., a spinning nozzle hot air temperature of 220° C.-250° C. and a spinning pressure of 4.5 MPa-10 MPa. The TPU adhering layer 14 has a melting point of 90-130° C.

Referring to step S23, a TPU layer 15 is melt-blown onto a surface 141 of the TPU adhering layer 14. In an embodiment, the step of melt-blowing the TPU layer 15 further includes the following operations. TPU particles, having a melting point of 150-180° C. and a Shore hardness of 70-90 A, are dried at a predetermined drying temperature for 4 hours until the water content is 100 ppm or below. The predetermined drying temperature is 80° C.

In an embodiment, in the step of melt-blowing the TPU layer 15, the TPU particles are molten by a second extruder (not shown). The second extruder has a melting temperature of 90° C.-270° C., a die-head temperature of 210° C.-270° C., a DIE temperature of 240° C.-270° C., a spinning nozzle hot air temperature of 250° C.-270° C. and a spinning pressure of 4.5 MPa-10 MPa. The TPU layer 15 has a melting point of 150-220° C.

Referring to step S24, the substrate 11, the TPU adhering layer 14 and the TPU layer 15 are thermally bonded. In an embodiment, the thermal bonding is carried out using a plurality of flat ironing rollers (not shown). The flat ironing rollers include preheating rollers and pressing rollers. The preheating rollers have a temperature of 110° C.-160° C. The pressing rollers have a temperature of 50° C. The extrusion gap is 0.3-0.8 mm.

Referring to step S25, a bottom layer 16 is bonded onto a surface 151 of the TPU layer 15. In an embodiment, the step of bonding the bottom layer 16 is completed under conditions of an oven temperature of 70-140° C., an air volume of 300-1,800 rpm and an operating speed of 5-8 m/min. The bottom layer 16 is bonded to the TPU layer 15 by an aqueous glue or a high-solid glue. The bottom layer 16 may be a PU resin or a water-soluble PU resin. In an embodiment, a PU coating is used for surface coating to bond the bottom layer 16 onto the TPU layer 15.

Referring to step S26, a moldable surface layer 13 is prepared. In an embodiment, a moldable resin 13 is applied onto a release paper (not shown). The moldable resin may be mixed with a pearlescent or color paste, and the mixture may be applied onto the release paper and dried to provide surface color changes and texture.

Referring to step S27, an adhering glue layer 12 is applied onto a surface 131 of the moldable surface layer 13. In an embodiment, after the moldable surface layer 13 is dried, an adhering glue is applied onto the surface 131 of the moldable surface layer 13 and pre-dried to form the adhering glue layer 12.

Referring to step S28, the moldable surface layer 13 and the adhering glue layer 12 are bonded onto the first surface 111 of the substrate 11. In an embodiment, the step is completed under combined conditions of an oven temperature of 70-140° C., an air volume of 300-1,800 rpm, an operating speed of 5-8 m/min and a pressure of 3-6 kg/m².

In an embodiment, after the artificial leather 10 of the present disclosure is peeled from the release paper, subsequent processes such as high-frequency welding, male and female mold forming and vacuum forming can be carried out for forming as required. In the high-frequency welding process, the voltage is 40-90 V, the current value is 2-4 A, the mold temperature is 0-100° C., and the welding time is 2-15 s. In the male and female mold forming process, the upper mold temperature is 80-110° C., the lower mold temperature is 80-110° C., the hot pressing time is 1-5 min, and the pressure is 25-120 kg/cm². In the vacuum forming process, the heating temperature is 80-130° C., the heating time is 1-5 min, the vacuum forming time is 1-5 min, and the vacuum forming pressure is −760 mmHg.

Therefore, the manufacturing method of the artificial leather of the present disclosure does not need to use any solvent that is harmful to the environment, so as to meet the requirement of environmental friendliness. Besides, the artificial leather 10 of the present disclosure can be produced by the melt-blowing process, thereby saving the complicated process and time and improving the manufacturing efficiency. In addition, the moldable surface layer 13 of the artificial leather 10 of the present disclosure has a texture of leather or color effect. The bottom layer 16 has a villus effect and high wear resistance.

### Embodiment 1

100% recycled PET cotton or a mixture of 60% recycled PET and 40% common PET was entangled into a non-woven fabric by needle punching as a substrate 11.

TPU particles, having a Shore hardness of 70-90 A and a melting point of 100-150° C., were dried at a predetermined drying temperature of 80° C. for 4 hours until the measured water content was 100 ppm or below. Then, the TPU particles were molten by a first extruder. The first extruder had a temperature of 80° C., 180° C., 200° C., 210° C., 220° C. and 230° C. sequentially from the feed port to the discharge port, a die-head temperature of 230° C., a DIE temperature of 230° C., a spinning nozzle hot air temperature of 240° C. and a spinning pressure of 4.5 MPa-10 MPa. The melt-blown TPU adhering layer 14 was laid on the second surface 112 of the substrate 11 of the non-woven fabric in a fiber manner. The melt-blown TPU adhering layer 14 had an average fiber fineness of about 10 μm. The TPU adhering layer 14 had a stack thickness of about 0.15 mm.

TPU particles, having a Shore hardness of 70-90 A and a melting point of 150-180° C., were dried at a predetermined drying temperature of 80° C. for 4 hours until the measured water content was 100 ppm or below. Then, the TPU particles were molten by a second extruder. The second extruder had a temperature of 90° C., 200° C., 220° C., 230° C., 240° C. and 250° C. sequentially from the feed port to the discharge port, a die-head temperature of 250° C., a DIE temperature of 250° C., a spinning nozzle hot air temperature of 250° C. and a spinning pressure of 4.5 MPa-10 MPa. The melt-blown TPU layer 15 was laid on the TPU adhering layer 14 in a fiber manner. The melt-blown TPU layer 15 had an average fiber fineness of about 10 μm. The TPU layer 15 had a stack thickness of about 0.30 mm.

The laid three-layer structure (the substrate 11, the TPU adhering layer 14 and the TPU layer 15) was combined by flat ironing rollers. The preheating rollers had a temperature of 110° C. and 140° C. respectively. The pressing rollers had a temperature of 50° C. The extrusion gap is 0.75 mm. The production speed was 9 m/min.

The TPU layer 15 was ground to increase the hairiness. The conditions were as follows: the sand paper had a mesh size of 120-400, and the grinding speed was 600-1,000 rpm. A first sand paper had a mesh size of 120, the grinding speed was 800-1,000 rpm, and the TPU layer 15 was ground off by a thickness of 0.05 mm. Next, a second sand paper was used for grinding. The second sand paper had a mesh size of 150, the grinding speed was 800-1,000 rpm, and the TPU layer 15 was further ground off by a thickness of 0.05 mm. Next, a third sand paper was used for grinding. The third sand paper had a mesh size of 240, the grinding speed was 600-800 rpm, and dust on the exposed surface of the TPU layer 15 was fully removed. Next, a fourth sand paper was used for grinding. The fourth sand paper had a mesh size of 400, and the grinding speed was 600-800 rpm.

The bottom layer 16 was bonded to the ground surface 151 of the TPU layer 15. The bonding was completed under conditions of an oven temperature of 70-140° C., an air volume of 300-1,800 rpm and an operating speed of 5-8 m/min.

A moldable resin was applied onto a release paper. The moldable resin may be mixed with a pearlescent or color paste, and the mixture may be applied onto the release paper and dried to provide surface color changes and texture of the moldable surface layer 13.

After the moldable surface layer 13 was dried, an adhering glue was applied onto the surface 131 of the moldable surface layer 13 and pre-dried to form the adhering glue layer 12.

Under conditions of an oven temperature of 70-140° C., an air volume of 300-1,800 rpm, an operating speed of 5-8 m/min and a pressure of 3-6 kg/m², the moldable surface layer 13 and the adhering glue layer 12 were bonded onto the first surface 111 of the substrate 11 so as to obtain the artificial leather.

Results of a peeling strength test show that the peeling strength of the artificial leather of this example is 3 Kg/cm or above (test method: NIKE G44). The ambient-temperature flex resistance can reach 100,000 cycles or above (SATRA PM55), and the softness can reach 2.3-3.0 (softness tester ST300). In addition, the artificial leather of this example has the characteristic of no curling. Compared with the conventional artificial leather having a curling height of 1 cm or above, the artificial leather of this example is more suitable for requirements of automatic production.

### Embodiment 2

100% recycled PET fibers or common PET fibers was woven into a woven fabric as a substrate 11.

TPU particles, having a Shore hardness of 70-90 A and a melting point of 100-150° C., were dried at a predetermined drying temperature of 80° C. for 4 hours until the measured water content was 100 ppm or below. Then, the TPU particles were molten by a first extruder. The first extruder had a temperature of 80° C., 180° C., 200° C., 210° C., 220° C. and 230° C. sequentially from the feed port to the discharge port, a die-head temperature of 230° C., a DIE temperature of 230° C., a spinning nozzle hot air temperature of 240° C. and a spinning pressure of 4.5 MPa-10 MPa. The melt-blown TPU adhering layer 14 was laid on the second surface 112 of the substrate 11 of the non-woven fabric in a fiber manner. The melt-blown TPU adhering layer 14 had an average fiber fineness of about 10 μm. The TPU adhering layer 14 had a stack thickness of about 0.15 mm.

TPU particles, having a Shore hardness of 70-90 A and a melting point of 150-180° C., were dried at a predetermined drying temperature of 80° C. for 4 hours until the measured water content was 100 ppm or below. Then, the TPU particles were molten by a second extruder. The second extruder had a temperature of 90° C., 200° C., 220° C., 230° C., 240° C. and 250° C. sequentially from the feed port to the discharge port, a die-head temperature of 250° C., a DIE temperature of 250° C., a spinning nozzle hot air temperature of 260° C. and a spinning pressure of 4.5 MPa-10 MPa. The melt-blown TPU layer 15 was laid on the TPU adhering layer 14 in a fiber manner. The melt-blown TPU layer 15 had an average fiber fineness of about 10 μm. The TPU layer 15 had a stack thickness of about 0.30 mm.

The laid three-layer structure (the substrate 11, the TPU adhering layer 14 and the TPU layer 15) was combined by flat ironing rollers. The preheating rollers had a temperature of 110° C. and 140° C. respectively. The pressing rollers had a temperature of 50° C. The extrusion gap is 0.75 mm. The production speed was 9 m/min.

The TPU layer 15 was ground to increase the hairiness. The conditions were as follows: the sand paper had a mesh size of 120-400, and the grinding speed was 600-1,000 rpm. A first sand paper had a mesh size of 120, the grinding speed was 800-1,000 rpm, and the TPU layer 15 was ground off by a thickness of 0.05 mm. Next, a second sand paper was used for grinding. The second sand paper had a mesh size of 150, the grinding speed was 800-1,000 rpm, and the TPU layer 15 was further ground off by a thickness of 0.05 mm. Next, a third sand paper was used for grinding. The third sand paper had a mesh size of 240, the grinding speed was 600-800 rpm, and dust on the exposed surface of the TPU layer 15 was fully removed. Next, a fourth sand paper was used for grinding. The fourth sand paper had a mesh size of 400, and the grinding speed was 600-800 rpm.

The bottom layer 16 was bonded to the ground surface 151 of the TPU layer 15. The bonding was completed under conditions of an oven temperature of 70-140° C., an air volume of 300-1,800 rpm and an operating speed of 5-8 m/min.

A moldable resin was applied onto a release paper. The moldable resin may be mixed with a pearlescent or color paste, and the mixture may be applied onto the release paper and dried to provide surface color changes and texture of the moldable surface layer 13.

After the moldable surface layer 13 was dried, an adhering glue was applied onto the surface 131 of the moldable surface layer 13 and pre-dried to form the adhering glue layer 12.

Under conditions of an oven temperature of 70-140° C., an air volume of 300-1,800 rpm, an operating speed of 5-8 m/min and a pressure of 3-6 kg/m′, the moldable surface layer 13 and the adhering glue layer 12 were bonded onto the first surface 111 of the substrate 11 so as to obtain the artificial leather.

Results of a peeling strength test show that the peeling strength of the artificial leather of this example is 1 Kg/cm or above (test method: NIKE G44). The ambient-temperature flex resistance can reach 100,000 cycles or above (SATRA PM55), and the softness can reach 4.0-4.5 (softness tester ST300). In addition, the artificial leather of this example has the characteristic of no curling. Compared with the conventional artificial leather having a curling height of 1 cm or above, the artificial leather of this example is more suitable for requirements of automatic production.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. An artificial leather, comprising:
a substrate, having a first surface and a second surface, the second surface being opposite to the first surface;
an adhering glue layer, disposed on the first surface of the substrate;
a moldable surface layer, disposed on the adhering glue layer;
a TPU adhering layer, disposed on the second surface of the substrate;
a TPU layer, disposed on a surface of the TPU adhering layer; and
a bottom layer, disposed on a surface of the TPU layer.

2. The artificial leather of claim 1, wherein the adhering glue layer has a solid content of 20%-99% and a viscosity of 5,000-50,000 cps.

3. The artificial leather of claim 1, wherein the moldable surface layer has a solid content of 10%-99% and a viscosity of 500-15,000 cps.

4. The artificial leather of claim 3, wherein the moldable surface layer is a moldable resin.

5. The artificial leather of claim 1, wherein the substrate is a woven fabric or a non-woven fabric.

6. The artificial leather of claim 5, wherein a fiber fineness of the substrate is 0.05-6 μm.

7. The artificial leather of claim 1, wherein the bottom layer has a solid content of 5%-50% and a viscosity of 20-2,000 cps.

8. The artificial leather of claim 7, wherein the bottom layer is a resin.

9. A manufacturing method of an artificial leather, comprising:
preparing a substrate, the substrate having a first surface and a second surface, the second surface being opposite to the first surface;
melt-blowing a TPU adhering layer onto the second surface of the substrate;
melt-blowing a TPU layer onto a surface of the TPU adhering layer;
thermally bonding the substrate, the TPU adhering layer and the TPU layer;
bonding a bottom layer onto a surface of the TPU layer;
preparing a moldable surface layer;
applying an adhering glue layer onto a surface of the moldable surface layer; and
bonding the moldable surface layer and the adhering glue layer onto the first surface of the substrate.

10. The manufacturing method of claim 9, wherein in the step of melt-blowing the TPU adhering layer, low-melting TPU particles, having a melting point of 100-150° C. and a Shore hardness of 70-90 A, are dried at a predetermined drying temperature for 4 hours until the water content is 100 ppm or below.

11. The manufacturing method of claim 10, further comprising a step of using a first extruder to melt the TPU particles, the first extruder has a melting temperature of 80° C.-250° C., a die-head temperature of 210° C.-250° C., a DIE temperature of 210° C.-250° C., a spinning nozzle hot air temperature of 220° C.-250° C. and a spinning pressure of 4.5 MPa-10 MPa.

12. The manufacturing method of claim 9, wherein in the step of melt-blowing the TPU layer, TPU particles, having a melting point of 150-180° C. and a Shore hardness of 70-90 A, are dried at a predetermined drying temperature for 4 hours until the water content is 100 ppm or below.

13. The manufacturing method of claim 12, further comprising a step of using a second extruder to melt the TPU particles, the second extruder has a melting temperature of 90° C.-270° C., a die-head temperature of 210° C.-270° C., a DIE temperature of 240° C.-270° C., a spinning nozzle hot air temperature of 250° C.-270° C. and a spinning pressure of 4.5 MPa-10 MPa.

14. The manufacturing method of claim 9, wherein the step of thermal bonding further comprises: using a plurality of flat ironing rollers, having preheating rollers and pressing rollers, the preheating rollers have a temperature of 110° C.-160° C., the pressing rollers have a temperature of 50° C., the extrusion gap is 0.3-0.8 mm.

15. The manufacturing method of claim 9, wherein the step of bonding the bottom layer is completed under conditions of an oven temperature of 70-140° C., an air volume of 300-1,800 rpm and an operating speed of 5-8 m/min.

16. The manufacturing method of claim 9, wherein in the step of preparing the moldable surface layer, a moldable resin is applied onto a release paper.

17. The manufacturing method of claim 9, wherein the step of bonding the moldable surface layer and the adhering glue layer onto the first surface of the substrate is completed under combined conditions of an oven temperature of 70-140° C., an air volume of 300-1,800 rpm, an operating speed of 5-8 m/min and a pressure of 3-6 kg/m².
